(19) United States
(12) Patent Application Publication
(10) Pub. No.: US 2008/0242370 A1
(43) Pub. Date: Oct. 2, 2008

(54) EFFICIENT SERVER POLLING SYSTEM AND METHOD

(75) Inventors: Noam LANDO, Kfar Saba (IL); Amit HALLER, Belmont, CA (US)

Correspondence Address: MERCHANT & GOULD PC, P.O. BOX 2903, MINNEAPOLIS, MN, 55402-0903, US

(73) Assignee: IXI Mobile (R&D) Ltd., Raanana (IL)

(21) Appl. No.: 11/864,271

(22) Filed: Sep. 28, 2007

Related U.S. Application Data
(63) Continuation-in-part of application No. PCT/IL2006/000413, filed on Mar. 31, 2006.

(51) Int. Cl. H04B 1/38; H04Q 7/20

(52) U.S. Cl. 455/574; 455/466

(57) ABSTRACT

A method of requesting content from a communication server in a mobile communication network is provided. The method comprises determining whether the mobile device is in a first mode; requesting content for delivery to the mobile device, while the mobile device is in the first mode; and discontinuing requesting the content if the mobile device is in a second mode, wherein the first mode is distinguished from the second mode based on length of lack of user interaction with the mobile device to perform one or more functions.

### FIELD OF THE INVENTION

The present invention relates generally to mobile communication services and, more particularly, to a system and method for requesting content to be delivered to a mobile communication device in a manner that reduces power consumption.

### BACKGROUND OF THE INVENTION

Mobile communication devices such as cellular phones and personal digital assistants (PDAs) are generally battery operated and have limited storage and display features. Despite recent improvements in battery life and data storage technologies, it is still quite important to manage the operation of a mobile device and its data storage resources such that the battery life and free storage space are maximized. This is particularly important as mobile devices are operated to handle a great variety of tasks that go beyond mere voice communications. Particularly, many mobile devices are configured to poll content providers or server systems connected to a wireless communication network to determine if any content is pending for delivery to the mobile device. Examples of such content include audio/video data streams, text messages, emails, or other information such as stock quotes, weather, news, etc.

Typically, a mobile device is configured to poll one or more servers in predetermine time intervals to determine if new content is available for delivery. Thus, the mobile device will be utilizing the mobile device's power resources (e.g., battery) at each predetermined time interval, whether or not new information or content has become available. As such, if the mobile device is configured to poll one or more servers frequently, the mobile device will have to wake up frequently thereby a constant drain on its battery.

Since in most instances new data may not be available for delivery to the mobile device, this periodic polling method is inefficient. That is, each polling request submitted to a server that results in no new content being delivered to the mobile device is a waste of mobile device's power. Furthermore, even if each polling request results in delivery of new content to the mobile device, in many cases the new data is not viewed or used by the user of the mobile device instantly when it is delivered.

Thus, under circumstances where the real-time receipt or storage of content is unnecessary, there is no real need for the mobile device to transmit a polling request for delivery of new content to the one or more content servers at each predetermined time interval. More particularly, the receipt or storage of such data while the user is not using the device is unnecessary and a strain on the battery, storage capacity, and other resources of the mobile device.

There is a need to determine when the real-time delivery of information is beneficial to the user, so that the proper timing for providing the user with the needed content can be determined and the polling activity of the mobile device can be minimized.

### SUMMARY OF THE INVENTION

The present disclosure is directed to a system and corresponding methods that facilitate the optimization of battery life for a mobile communication device by requesting delivery of content to the mobile device in instances that a user is actively utilizing the mobile device. In certain embodiments, content is either queued or forwarded in real-time to the mobile device when it is determined that the mobile device is in an active state.

For purposes of summarizing, certain aspects, advantages, and novel features of the invention have been described herein. It is to be understood that not all such advantages may be achieved in accordance with any one particular embodiment of the invention. Thus, the invention may be embodied or carried out in a manner that achieves or optimizes one advantage or group of advantages as taught herein without achieving other advantages as may be taught or suggested herein.

In accordance with one embodiment, a method of polling a server in a mobile communication network is provided. The method comprises determining whether the mobile device is in a first mode; polling at least one server for delivery of data while the mobile device is in the first mode; and discontinuing the polling, if the mobile device is in a second mode.

In some embodiments, the first mode is distinguished from the second mode based on the length of user interaction with the mobile device. The user interaction is measured based on user utilizing the mobile device to perform one or more functions or the degree with which power resources of the mobile device is utilized, for example.

In one embodiment, the first mode is an active mode and the second mode is an inactive mode. The determination of whether the mobile device is in the first mode, can be performed based on status information sent from the mobile device, wherein the status information can be in predetermined time intervals. The status information comprises information about whether the mobile device is in the first mode or the second mode. The discontinuation of the data delivery polling can also be performed based on status information sent from the mobile device.

In accordance with yet another embodiment, a method of requesting content from a communication server in a mobile communication network comprises determining whether the mobile device is in a first mode; requesting content for delivery to the mobile device, while the mobile device is in the first mode; and discontinuing of requesting the content, if the mobile device is in a second mode, wherein the first mode is distinguished from the second mode based on length of lack of user interaction with the mobile device to perform one or more functions.

In a preferred embodiment, the first mode is when the mobile device is in an active Instant Messaging (IM) state and the second mode is when the mobile device is not in an active (IM) state. The active IM state is defined as the time when the mobile device is set to send or receive instant messages communications in real-time, as well as presence updates. In the first mode, i.e. in active (IM) state, a request for content may be sent to a communication server in a mobile communication network, comprising a message that the mobile device is in an active IM state, and where the requested content for delivery to the mobile device is the status information of other mobile devices in the communication network. Presence data and updates of other devices may be kept in a list held by the communication server or sent to the mobile device with the request for content. This information is not useful to the user when the mobile device is in the second mode, and uses up bandwidth and power. Therefore the request for content may continue periodically while the mobile device is in the active IM state mode, and discontinued when the mobile device is in the second mode. The second mode may be achieved by a specific request sent from the mobile device, or automatically when the mobile device ceases to send a request for content for a predetermined length of time or by any other indications. When the mobile device is in the second mode, all the messages of presence update sent from other devices to the server and intended for the mobile device are aggregated and saved until the mobile device enters the first mode, for future delivery to the mobile device. However, historical information is preferably not delivered and the user only receives up-to-date presence updates regarding the status of other users of the network.

In a preferred embodiment, the first mode is when the mobile device is in a full-sync E-mail mode and the second mode is when the mobile device is in partial-sync E-mail mode. The full-sync E-mail mode is defined as the time when the mobile device is set to fully synchronize with the server in real-time, whereas in the partial-sync mode the mobile device allows to sync new E-mails but not to synchronize changes relating to actions such as marking of e-mails as read/unread, the deleting or archiving of E-mails, and other maintenance activities. Furthermore, in modern e-mail systems different clients may perform update and delete operations on the e-mail messages stored on the server and it is not uncommon for the owner of a mobile device to use other e-mail clients when the mobile device is in the first mode, or even switched off altogether. Thus, according to the present invention a situation may exist according to which the e-mail information available at the mobile device is not synchronized with the up-to-date e-mail status information on the e-mail server. While, obviously, being always fully synchronized is, generally speaking, a desirable state, in e-mail communication the continuous synchronization imposes a heavy burden on the resources of the mobile device, both as regards bandwidth and power consumption. It is therefore desirable to differentiate between a first and a second mode, in which the user does not possess up-to-date, synchronized e-mail status information in his mobile device, while being able to continue to enjoy critical information, such as the headers or content of new messages sent to him.

When switching to the first mode, a request for full synchronization may be sent to a communication server in a mobile communication network, comprising a message that the mobile device is in the first E-mail mode. The full synchronization may continue periodically while the mobile device is in the first mode, and is discontinued when the mobile device is in the second mode. The second mode may be initiated by a specific request sent from the mobile device, or when the mobile device ceases to send a request for full synchronization for a predetermined length of time, or by any other status information generated by the mobile device or by the server. When the mobile device is in the second mode, only partial synchronization takes place (e.g., only new messages are delivered, fully or only as headers) and the remaining of the synchronization information is kept for later synchronization, when the mobile device switches again to the first, full-sync mode.

In one embodiment, in the first mode the mobile terminal utilizes a power resource of the mobile device more than when the mobile device is in the second mode. The status information, in one embodiment, can be based on at least one of whether a user has interacted with the mobile device's user interface during a threshold period, whether the mobile device's cover is in an open position, and whether the mobile device's illumination unit is turned on. These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 illustrates an exemplary communications environment, in accordance with one or more embodiments of the invention;

FIG. 2 is a flow diagram of a method for polling a communication server for delivery of content to a mobile device, in accordance with one or more embodiments; and

FIGS. 3A and 3B are block diagrams of hardware and software environments in which a system of the present invention may operate, in accordance with one or more embodiments.

### DETAILED DESCRIPTION OF PREFERRED EMBODIMENTS

An electronic system and corresponding methods, according to an embodiment of the present invention, facilitate and provide a method and system for optimizing power consumption in a mobile communication device by requesting transmission of content to the mobile communication device based on whether or not the device is in an active status.

Electronic services, services, and online services are used interchangeably herein. The services provided by the system of this invention, in one or more embodiments, are provided by a content provider. A content provider is an entity that operates and maintains the computing systems and environment, such as server systems and infrastructures that enable the delivery of information. Typically, server architecture includes components (e.g., hardware, software, and communication lines) that store and offer electronic or online services.

In the following, numerous specific details are set forth to provide a thorough description of various embodiments of the invention. Certain embodiments of the invention may be practiced without these specific details or with some variations in detail. In some instances, features not pertinent to the novelty of the system are described in less detail so as not to obscure other aspects of the invention.

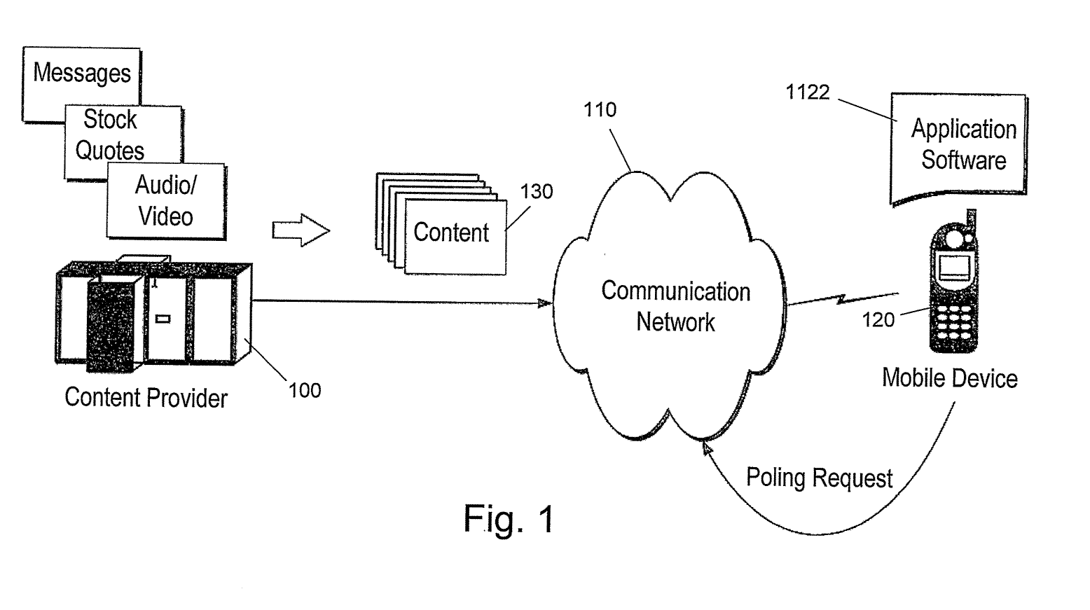

Referring to the drawings, FIG. 1 illustrates an exemplary communications environment in which the system of the present invention may operate. In accordance with one aspect of the system, the system environment comprises a content provider 100, a communication network 110, and a mobile device 120. The content provider 100 and mobile device 120 are connected by way of the communication network 110. The terms “connected,” “coupled,” or any variant thereof, mean any connection or coupling, either direct or indirect, between two or more elements. The coupling or connection between the elements can be physical, logical, or a combination thereof.

In one embodiment, the communication network 110 provides the medium and infrastructure for transmitting digital or analog signals between content provider 100 and mobile device 120. In certain embodiments, mobile device 120 is a cellular telephone and communication network 110 is a wireless telephone network, for example. Mobile device 120, content provider 100 and communication network 110, however, may be implemented over any type of mobile, fixed, wired or wireless communication technology (e.g., landline telephony, cellular, radio, radar, infrared, etc.).

One of ordinary skill in the art will appreciate that communication network 110 may advantageously be comprised of one or a combination of various types of networks without detracting from the scope of the invention. Such networks can, for example, comprise personal area networks (PANs), local area networks (LANs), wide area networks (WANs), public, private or secure networks, value-added networks, interactive television networks, wireless communications networks, two-way cable networks, satellite networks, interactive kiosk networks, cellular networks, personal mobile gateways (PMGs) and/or any other suitable communications networks that can provide a means of communication between mobile device 120 and content provider 100.

In some embodiments, communication network 110 can be a part of the world wide web (i.e., the Internet). The Internet, in a well-known manner, connects millions of computers world wide through standard common addressing systems and communications protocols (e.g., Transmission Control Protocol/Internet Protocol (TCP/IP), HyperText Transport Protocol) creating a vast communications network.

In either context, mobile device 120 can communicate with content provider 100 to send and receive electronic packets of information, in form of electronic requests (i.e., polling) and responses. In a particular embodiment, the packets are constructed to comprise information about the status of mobile device 120. That is, certain packets communicated from mobile device 120 include information in form of data bits that indicate whether mobile device 120 is in an active or inactive status, for example.

The operational status of mobile device 120 can be determined, depending on implementation, in several different manners. For example, if mobile device 120 is a clamshell design phone, or includes a flip cover, then when the mobile device 120 or the cover is in an open position, it is assumed that mobile device 120 is in an active status. That is, a user can actively view or hear information transmitted to mobile device 120.

In another embodiment, an active status is determined when a user interacts with a user interface of mobile device 120 or while a predetermined amount of time has lapsed after the user last interacted with a user interface of mobile device 120. In yet another embodiment, an active status is determined if a backlight of mobile device 120 is illuminated. In some embodiment, a motion sensor or other sensing mechanism may be included in mobile device 120 to determine if mobile device 120 is in an active or inactive status.

Accordingly, in one embodiment, content provider 100 services content requests submitted by mobile device 120 to determine content 130 that needs to be downloaded to mobile device 120, when mobile device 120 is in the active mode. In certain embodiments, content provider 100 is a backend server that forwards content 130 to a phone number or network address (e.g., IP address) associated with mobile device 120.

Content provider 100 can download to mobile device 120 various forms of content 130, in accordance with other aspects of the system. For example, the content 130 may comprise text messages, emails, images, voice, streaming audio/video, stock quotes, weather information and other data services that may be supported and delivered to a mobile device 120 by content provider 100.

In one embodiment, content provider 100 is a wireless communications content provider (e.g., Sprint, AT&T, Verizon, etc.) that can service content requests from devices connected to communication network 110. For example, content provider 100 may comprise America On Line (AOL), Microsoft Network (MSN) and Yahoo. Depending on implementation, in one embodiment, content provider 100 receives may receive content requests either directly from mobile 120 or from another device connected thereto.

In an exemplary embodiment, mobile device 120 may periodically sends a content request to content provider 100. That is, if the status of mobile device 120 changes from active to inactive, for example, this change of status triggers the transmission a content request to content provider 100. For example, this content request procedure may be implemented by sending a content request message when mobile device 120 becomes active, and discontinuation message when mobile device 120 becomes inactive.

In certain embodiments, when mobile device 120 is in an active state it sends a content request message in predetermined time intervals so as to continuously receive new content that has become available on content provider 100. If content provider 100 does not receive a content request to that effect, then content provider 100 discontinues transmission of content to mobile device 120 after a threshold amount of time has passed. Other content request implementations may be possible. For example, a content provider may continue servicing mobile device 120's request for content until it receives a content discontinuation message.

In some embodiments, content provider 100 forwards one or more messages to mobile device 120 based on occurrence of certain events in real-time. For example, a user may subscribe to a financial, news, or sports broadcasting service which would forward a message to mobile device 120 in response to a stock price change, a heightened security level, or a game's score result, while mobile device 120 continues to poll content provider 100.

In a preferred embodiment, an active status of mobile device 120 is determined when it is in an Instant Messaging (IM) state. The device may switch to the IM active when the user actively turns mobile device 120 to an active IM state, or as a result of other modes commanded by the user. When mobile device 120 enters an IM active state it sends a request to content provider 100 to forward Presence data and updates of other relevant devices connected in the communication Network 110 for instant messaging with the device. Presence data and updates for those participants are held in a dynamically updated list stored in the content provider 100. The mobile device 120 may continue to poll the content provider 100 periodically for receiving an update of the present status information of the other devices. When mobile device 120 switches to non-active IM state a notification is sent to content provider 100 to update the status of mobile device 120. After receiving the notification, content provider 100 may aggregate all the status presence updates of the other mobile devices until mobile device 120 enters an active IM state again.

In a preferred embodiment, the first mode is when the mobile device 120 is in a full sync E-mail mode and the second mode is when the mobile device 120 is in partial-sync E-mail mode. The full-sync E-mail mode is defined as the time when the mobile device 120 is set to fully synchronize with the server in real-time, where in the partial-sync mode, the mobile device 120 allows to sync new E-mails but not to synchronize changes relating to actions such as the marking of e-mails as read/unread, the deleting or archiving of E-mails, or other maintenance activities. The full-sync E-mail mode may commence when the user switches mobile device 120 to an active E-mail mode. When mobile device 120 enters the first mode, it sends a request to content provider 100 to synchronize all non-synchronized information, including any new information or old information relating to housekeeping operations performed on the user's account using a different e-mail client. The mobile device 120 may continue to fully synchronize with the content provider 100. When mobile device 120 switches to the second E-mail mode, a notification is sent to content provider 100, thus stopping full synchronization and moving to partial or no synchronization mode. More than one mode can be available to the user on the mobile device, to choose from.

To manage the timing and frequency with which content is forwarded to mobile device 120, application software 1122 is installed or executed on one of mobile device 120, content provider 100, a third party portal, or a distributed environment that comprises one or more of said systems. As used herein, the terms mobile device, third party portal, content provider and communication network are to be viewed as designations of one or more computing environments that comprise application, client or server software for servicing requests submitted by respective software included in devices or other computing systems connected there to. These terms are not to be otherwise limiting in any manner. The application software, for example, may be comprised of one or more modules that execute on one or more computing systems, as described in further detail below.

In accordance with one aspect of the invention, application software 1122 is implemented to monitor status of mobile device 120. Application software 1122 monitors the active status of mobile device 120 by determining whether mobile device 120 is in active or inactive status. For example, when mobile device 120's backlight is switched from off to on, or when a user presses a key on mobile device 120's keypad, application software 1122 determines that mobile device 120 is in active status, and submits a request to receive any content 130 designated for mobile device 120 to content provider 100.

Upon receipt of the content request, content provider 100 determines if there is any content 130 to be delivered to mobile device 120 and then forwards any data queued for delivery or newly generated data to mobile device 120. On the other hand, if application software 1122 determines that a time period has passed since a user has interacted with mobile device 120's user interface, or if the backlight of mobile device 120 is changed from on to off, or if the user closes a cover of mobile device 120 then a non-active status notification is generated.

Once content provider 100 receives the non-active status notification, then it discontinues delivery of content 130 to mobile device 120. In another embodiment, a non-active status notification is not sent to content provider 100 when application software 120 detects an inactive status for mobile device 120. Instead, mobile device 120 simply discontinues requesting content 130 to be delivered by content provider 100. Not having received any request for delivery of content 130, content provider 100 queues any data that becomes available and delivers queued content after another request for content is received from mobile device 120.

It is noteworthy that the present invention is to be distinguished from a scenario when communication to a mobile device is interrupted or discontinued due to the mobile device being turned off. In accordance with one or more embodiments of the invention, mobile device 120 may be in an inactive status when mobile device 120 is on. Thus, various test parameters or status information may be used to determine if the user is not interacting with mobile device 120.

The above parameters may be based on duration of time the user has not interacted with a user interface of mobile device 120, duration of time or whether an illumination unit of mobile device 120 has been off, whether mobile device 120 is in open or close position, whether mobile device 120 is in motion, and other similar change of status indicators that can be used to predict if a user is actively using mobile device 120 or at least have it within an audio/visual sight.

In certain embodiments, application software 1122 may be utilized by a user to apply or adjust a delay threshold associated with a change of status indicator, such that a change in one status factor does not trigger a status notification message to be forwarded to content provider 100. For example, a user may open and close mobile device 120's cover, or accidentally press a button on its keypad.

Using a delay threshold, application software 1122 waits for another change of status indicator to be detected before sending a notification message. In this manner, accidental or minimal user interaction with mobile device 120 does not trigger content provider 100 to deliver or discontinue to deliver data to mobile device 120. In one embodiment, if the user does not set the delay threshold then a default value may be assigned automatically by content provider 100, application software 1122, or mobile device 120's manufacturer.

It should be noted that the above exemplary embodiments are not to be construed to limit the scope of the invention to a singular content provider 100, or application software 1122 that executes exclusively on the mobile device 120, or a change of status notification method that is limited to the examples provided above.

As noted above, application software 1122 may be implemented on a device or a system other than mobile device 120. For example, application software 1122 or its components may be implemented, installed, and executed either in a singular or in a distributed environment. That is, certain components of the application software may be installed and executed on mobile device 120, while other components may be executed and installed on a third party portal, one or more content providers 100, or other systems attached thereto.

The change of status notification method of this invention may be also implemented based on other factors that can be used to determine user interaction, such as level of light or acoustic waves surrounding mobile device 120, a break in an optical sensor circuit, etc. Furthermore, in certain embodiments, mobile device 120 may selectively request that content of certain type to be subject to delayed transmission, while other content types to be forwarded in real-time. For example, a user may select to receive traffic related information in real-time, and weather related information only at a specific time during the day.

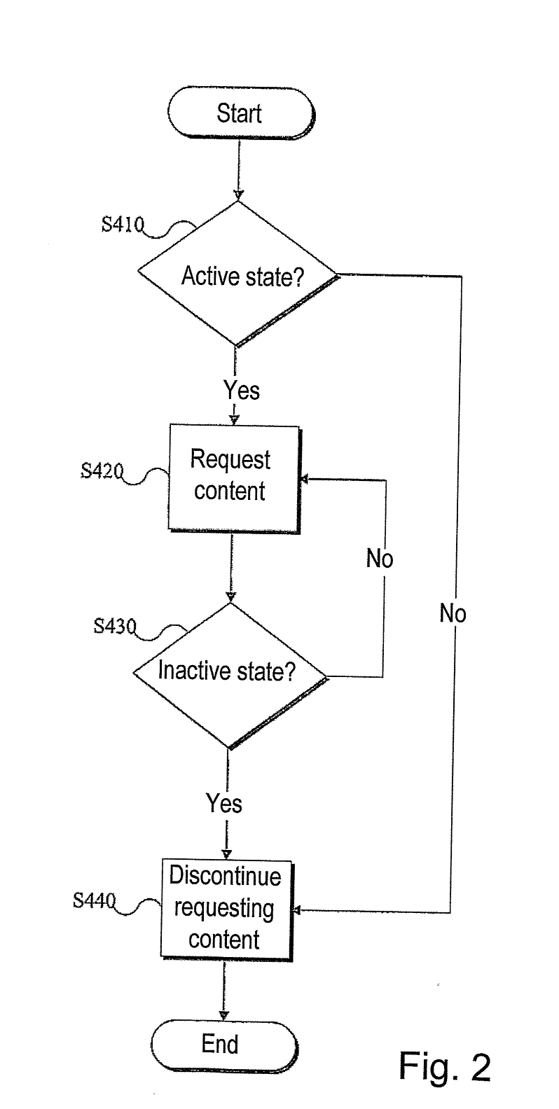

Referring to FIGS. 1 and 2, in accordance with one aspect of the invention, application software 1122 or a component thereof is executed on content provider 100 or mobile device 120 to determine if mobile device 120 is in an active state (S410). If mobile device 120 is in an active state, application software 1122 executed on mobile device 120 transmits one or more content requests to content provider 100 requesting content 130 (i.e., poll content provider 100 for content 130).

While mobile device 120 is in an active state, and when the requested content 130 is available, service provide 100 continues to transmit content 130 to mobile device 120 each time a content request is received (S420). In one embodiment, content 130 is transmitted to mobile device 120 based on each content request generated by application software 1120.

In certain embodiments, content 130 is queued in a storage space on content provider 100, for example, if mobile device 120 is not in an active state. In such scenario, queued content 130 is transmitted to mobile device 120, when application software 1122 reports to content provider 100 that mobile device 120 has become active.

If application software 1122 determines that mobile device 120 is in an inactive state (S430), then no further content requests are submitted and content provider 100 discontinues delivery of content 130 data to mobile device 120. The data delivery is later reinstated when application software 1122 determines that mobile device 120 has become active again and begins submitting request for content to content provider 100 (S410).

In one embodiment, if a first section of the data was transmitted prior to mobile device 120 going inactive, then the second portion of the data immediately following the first portion is transmitted, as soon as application software 1122 detects that mobile device 120 has become active. In this embodiment, the data that is generated while mobile device 120 has been inactive is queued and then transmitted as soon as mobile device 120 becomes active.

In other embodiments, content is not queued while mobile device 120 is in an inactive state. That is, data that would have been transmitted to mobile device 120 had it remained in the active state is lost. This is typical of content delivery systems, such as streaming audio/video (e.g., radio, television, etc.) wherein the content is being broadcasted in real-time or where content is constantly changing (e.g., stock market quotes).

Accordingly, some types of content 130 (e.g., email messages) are queued and other types of content 130 (e.g., stock quotes) are not. The above approach in delivering content 130 to mobile device 120 when it is determined to be in an active state advantageously allows mobile device 120 to remain in a power saving mode for a longer period of time because mobile device 120 will be no longer woken up at random intervals to request content 130 from content provider 100.

In accordance with one aspect of the invention, mobile device 120 continues to receive content 130 while in active mode until a threshold time period has passed during which conditions triggering active status of mobile device 120 are no longer detected by application software 1122. After the threshold time has expired, or in some embodiments in response to a user interaction (i.e., direct input), mobile device 120 switches to power saving mode (i.e., sleep mode) until a next condition triggering active status is detected.

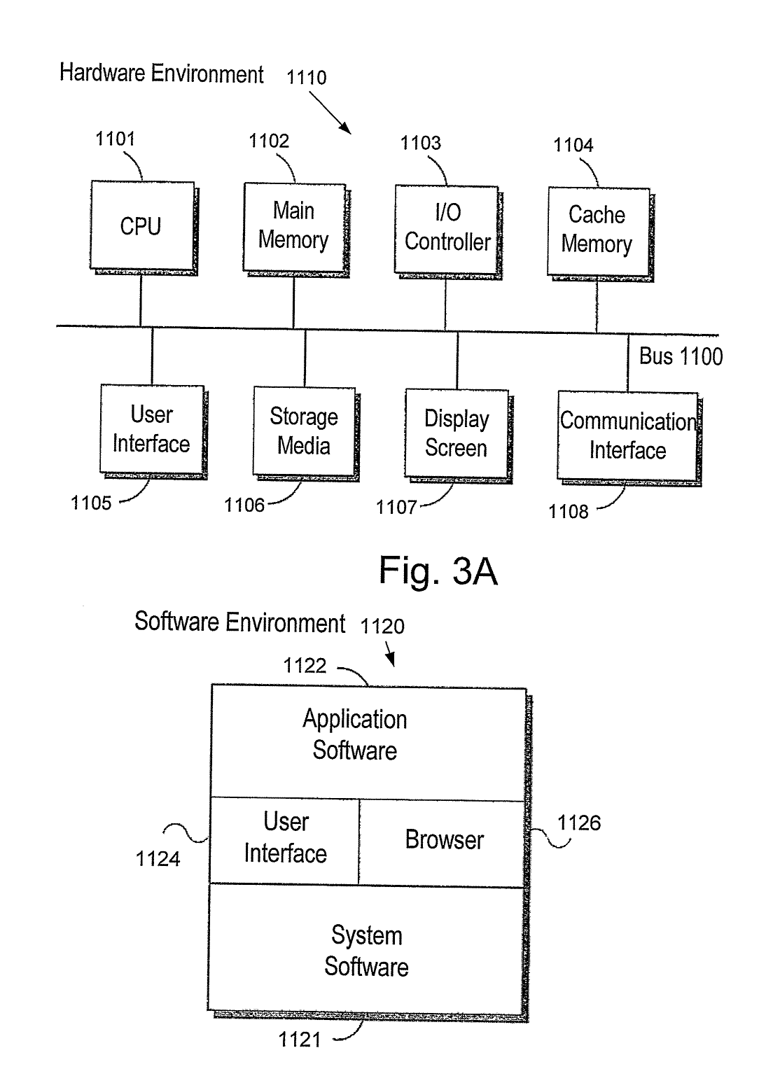

In one or more embodiments of the system, content provider 100, communication network 110, and mobile device 120 comprise a controlled computing system environment that can be presented largely in terms of hardware components and software code executed to perform processes that achieve the results contemplated by the system of the present invention. A more detailed description of such system environment is provided below with reference to FIGS. 3A and 3B.

As shown, a computing system environment is composed of two environments, a hardware environment 1110 and a software environment 1120. The hardware environment 1110 comprises the machinery and equipment that provide an execution environment for the software. The software provides the execution instructions for the hardware. It should be noted that certain hardware and software components may be interchangeably implemented in either form, in accordance with different embodiments.

Software environment 1120 is divided into two major classes comprising system software 1121 and application software 1122. System software 1121 comprises control programs, such as the operating system (OS) and information management systems that instruct the hardware how to function and process information.

Application software 1122 is a program that performs a specific task. In embodiments of the invention, system and application software are implemented and executed on one or more hardware environments to accommodate the transmission of real time content 130, for example, to mobile device 120 in accordance to the conditions set forth above.

Referring to FIG. 3A, an embodiment of application software 1122 can be implemented as computer software in the form of computer readable code executed on a general purpose hardware environment 1110 that comprises a central processor unit (CPU) 1101, a main memory 1102, an input/output controller 1103, optional cache memory 1104, a user interface 1105 (e.g., keypad, pointing device, etc.), storage media 1106 (e.g., hard drive, memory, etc.), a display screen 1107, a communication interface 1108 (e.g., a network card, a modem, or an integrated services digital network (ISDN) card, etc.), and a system synchronizer (e.g., a clock).

Processor 1101 may or may not include cache memory 1104 utilized for storing frequently accessed information. A communication mechanism, such as a bi-directional data bus 1100, can be utilized to provide for means of communication between system components. Hardware Environment 1110 is capable of communicating with local or remotes systems connected to a communications network (e.g., a PAN or a WAN) through communication interface 1108.

In one or more embodiments, hardware environment 1110 may not include all the above components, or may include additional components for additional functionality or utility. For example, hardware environment 1110 can be a laptop computer or other portable computing device that can send messages and receive data through communication interface 1108. Hardware environment 1110 may also be embodied in an embedded system such as a set-top box, a personal data assistant (PDA), a wireless communication unit (e.g., cellular phone), or other similar hardware platforms that have information processing and/or data storage and communication capabilities. For example, in embodiments of the system mobile device 120 may be a PMG phone or equivalent.

In embodiments of the system, communication interface 1108 can send and receive electrical, electromagnetic, or optical signals that carry digital data streams representing various types of information including program code. If communication is established via the Internet, hardware environment 1110 may transmit program code through an Internet connection. The program code can be executed by central processor unit 1101 or stored in storage media 1106 or other non-volatile storage for later execution. Program code may be transmitted via a carrier wave or may be embodied in any other form of computer program product. A computer program product comprises a medium configured to store or transport computer readable code or a medium in which computer readable code may be embedded. Some examples of computer program products are CD-ROM disks, ROM cards, floppy disks, magnetic tapes, computer hard drives, and network server systems.

In one or more embodiments of the invention, processor 1101 is a microprocessor manufactured by Motorola, Intel, or Sun Microsystems Corporations. The named processors are for the purpose of example only. Any other suitable microprocessor, microcontroller, or microcomputer may be utilized.

Referring to FIG. 3B, software environment 1120 is stored in storage media 1106 and is loaded into memory 1102 prior to execution. Software environment 1120 comprises system software 1121 and application software 1122. Depending on system implementation, certain aspects of software environment 1120 can be loaded on one or more hardware environments 1110.

System software 1121 comprises control software such as an operating system that controls the low-level operations of hardware environment 1110. Low-level operations comprise the management of the system's resources such as memory allocation, file swapping, and other core computing tasks. In one or more embodiments of the invention, the operating system comprises at least one of Symbian, Nucleus, Microsoft Windows, Palm, or Macintosh operating systems. However, any other suitable operating system may be utilized.

Application software 1122 can comprise one or more computer programs that are executed on top of system software 1121 after being loaded from storage media 1106 into memory 1102. In client-server architecture, application software 1122 may comprise client software and server software. Referring to FIG. 1, for example, in one embodiment of the invention, client software is executed on mobile device 120 and server software is executed on content provider 100.

Software environment 1120 may also comprise web browser software 1126 for communicating with the Internet. Further, software environment 1120 may comprise a user interface 1124 (e.g., a Graphical User Interface (GUI)) for receiving user commands and data. The commands and data received are processed by the software applications that run on the hardware environment 1110. The hardware and software architectures and environments described above are for purposes of example only. Embodiments of the invention may be implemented in any type of system architecture or processing environment.

Embodiments of the invention are described by way of example as applicable to systems and corresponding methods that facilitate optimizing power consumption in a mobile device. In this exemplary embodiment, logic code for performing these methods is implemented in the form of, for example, application software 1122. The logic code, in one embodiment, may be comprised of one or more modules that execute on one or more processors in a distributed or non-distributed communication model.

It should also be understood that the programs, modules, processes, methods, and the like, described herein are but an exemplary implementation and are not related, or limited, to any particular computer, apparatus, or computer programming language. Rather, various types of general-purpose computing machines or devices may be used with logic code implemented in accordance with the teachings provided, herein. Further, the order in which the steps of the present method are performed is purely illustrative in nature. In fact, the steps can be performed in any order or in parallel, unless indicated otherwise in the present disclosure.

The method of the present invention may be performed in either hardware, software, or any combination thereof. In particular, the present method may be carried out by software, firmware, or macrocode operating on a computer or computers of any type. Additionally, software embodying the present invention may comprise computer instructions and be stored in a recording medium (e.g., memory stick, ROM, RAM, magnetic media, punched tape or card, compact disk (CD), DVD, etc.). Furthermore, such software may be transmitted in the form of a computer signal embodied in a carrier wave, and through communication networks by way of Internet portals or websites, for example. Accordingly, the present invention is not limited to any particular platform, unless specifically stated otherwise in the present disclosure.

The present invention has been described above with reference to preferred embodiments. However, those skilled in the art will recognize that changes and modifications may be made in these preferred embodiments without departing from the scope of the present invention.

The embodiments described above are to be considered in all aspects as illustrative only and not restrictive in any manner. Thus, other system architectures, platforms, and implementations that can support various aspects of the invention may be utilized without departing from the essential characteristics as described herein. These and various other adaptations and combinations of features of the embodiments disclosed are within the scope of the invention. The invention is defined by the claims and their full scope of equivalents.

1. A method for the efficient utilization of the resources of a mobile device during Instant Messaging (IM) operation, comprising:
a. determining whether said mobile communication device is in a first mode which is an active IM state, or in a second mode which is not in active IM state, said determining being effected by the transmission of data from the device to the server, said data being representative of an activity state of the device;
b. if said device is in first mode:
I. receiving from at least one said server presence updates of at least one other device operating in IM mode;
c. if said device is said second mode, aggregating said status information messages in said server; and
d. when an indication is received by the server, representative of said mobile device having switched from said second to said first mode, delivering to said mobile device only the up-to-date presence updates.

2. The method of claim 1, wherein the determining is performed based on status information detected by the mobile device.

3. The method of claim 2, wherein the status information comprises information about whether the mobile device is in the first mode.

4. The method of claim 2, wherein the status information comprises information about whether the mobile device is in the second mode.

5. The method of claim 1, wherein the aggregating of status information is performed based on status information detected by the mobile device.

6. The method of claim 2, wherein the status information is determined by the mobile device in predetermined time intervals.

7. The method of claim 5, wherein the status information is based on at least one of whether a user has interacted with the mobile device's user interface during a threshold period, whether the mobile device's cover, if existing, is in an open position, and whether the mobile device's illumination unit is turned on, or if another application is being used.

8. A method for the efficient utilization of the resources of a mobile device during e-mail operations comprising:
a. generating status information representative of whether the mobile device is in a first mode or in a second mode and continuously determining said status;
b. periodically synchronizing e-mail information on the mobile device with the e-mail server, when in said first mode; and
c. if the mobile device is in said second mode, only partially synchronizing selected information updated on the e-mail server, thereby to maintain an unsynchronized state of the mobile device, relative to the e-mail server.

9. The method of claim 8, wherein the selected information comprises new e-mail messages.

10. The method of claim 8, wherein the selected information comprises the headers of new messages.

11. The method of claim 8, wherein the determining is performed based on status information detected by the mobile device.

12. The method of claim 11, wherein the status information comprises information about whether the mobile device is in the first mode.

13. The method of claim 11, wherein the status information comprises information about whether the mobile device is in the second mode.

14. The method of claim 11, wherein the status information is determined by the mobile device in predetermined time intervals.

15. The method of claim 11, wherein the status information is based on at least one of whether a user has interacted with the mobile device's user interface during a threshold period, whether the mobile device's cover is in an open position, and whether the mobile device's illumination unit is turned on.
